(19) United States
(12) Patent Application Publication
(10) Pub. No.: US 2008/0095971 A1
(43) Pub. Date: Apr. 24, 2008

(54) Laminated Polyisocyanurate Foam Structure with Improved Astm E-84 Flame Spread Index and Smoke Developed Index

(76) Inventors: Robert L. McGee, Midland, MI (US); Melvin L. Rasco, Lake Jackson, TX (US); Anil G. Shenoy, Midland, MI (US)

Correspondence Address: The Dow Chemical Company, Intellectual Property Section, P.O. Box 1967, Midland, MI, 48641-1967, US

(21) Appl. No.: 11/666,529

(22) PCT Filed: Nov. 17, 2005
(86) PCT No.: PCT/US05/41764

§ 371 Date: Apr. 27, 2007

Related U.S. Application Data
(60) Provisional application No. 60/631,215, filed on Nov. 24, 2004.
(60) Provisional application No. 60/650,360, filed on Feb. 4, 2005.

(51) Int. Cl. B32B 3/00

(52) U.S. Cl. 428/71

(57) ABSTRACT

Improve ASTM E-84 flame spread index and smoke developed index ratings of polyisocyanurate or urethane-modified isocyanurate foams by coating one or both major planar surfaces of a foam body or board with an intumescent coating material that contains expandable graphite and a silicate. If desired, provide reinforcement for the intumescent coating when it intumesces using a material such as a carbon veil mat or a fiberglass mat. Add a moisture vapor barrier layer to minimize water-induced degradation or water absorption of the foam.

This invention relates generally to building products, particularly to building panels and insulation for piping or process equipment, more particularly to building products known as “sandwich-type” structures. Such structures generally comprise a pair of facing sheets that have sandwiched therebetween a central core of an expanded cellular polymerized resinous material, commonly referred to as “foam”, “resin foam” or a “plastic foam” core. This invention relates more particularly to such building products that have a laminar structure made of a plurality of select laminae that allow the products to attain a satisfactory American Society for Testing and Materials (ASTM) Test E-84 flame spread index (FSI) and smoke developed index (SDI) for certain applications. For air return plenums that carry insulated hot water pipes and insulated cold water pipes in commercial buildings such as schools, office buildings and hospitals, satisfactory ASTM E-84 FSI and SDI numbers are, respectively, 25 and 50. Building panels have the same FSI, but increase the acceptable SDI to 450.

Fire performance test protocols and standards vary from country to country and a single country may have more than one acceptable fire performance test protocol or accepted standard. Irrespective of the test protocol or standard, the products of this invention should provide improved performance relative to products that lack one or more laminae, layers or strata of the laminar structure of the present invention.

Producers of plastic foam have been, and continue to be, under regulatory and legislative pressure to replace halogenated blowing agents with blowing agents that are more environmentally friendly. “Environmentally friendly” refers to blowing agents that have a reduced ozone-depletion tendency or that generate a lower level of so-called “greenhouse gases”, in both cases relative to halogenated blowing agents, especially chlorofluorocarbons. Hydrocarbon blowing agents, such as butanes or pentanes, may fall in the environmentally friendly blowing agent category, but their flammability poses other challenges. For example, attaining a satisfactory ASTM E-84 rating with a flammable blowing agent such as pentane is far more difficult than with a relatively non-flammable blowing agent such as 1,1-dichloro-1-fluoroethane (HCFC-141b) or 1,1,1,2-tetrafluoroethane (HFC-134a).

Unprotected plastic foams, especially polyisocyanurate (PIR) foams and urethane-modified polyisocyanurate (PU-PIR) foams that contain residual flammable blowing agent, tend to disintegrate when exposed to flames of a direct fire. As charred or burning foam disintegrates, falls apart or flakes off from a foam body, a fresh foam surface is exposed to the flames. This manifests itself as a relatively high FSI, high SDI or both, either of which may cause foam to fail ASTM E-84 testing.

Some plastic foam manufacturers, most notably those who manufacture PIR foam and PU-PIR foam, use a facer to protect the foam surface from direct flame. Currently available facer materials suffer one or more shortcomings. For example, the facer material may aggravate smoke generation by allowing charred PIR or PU-PIR foam to smolder underneath unburned facer. Other facers, such as aluminum foil, may provide flame protection of limited duration before they flake off or disintegrate, exposing foam surfaces to the flame. Still other facers fail to provide adequate barrier to water vapor penetration. Yet other facers readily suffer damage from physical insults such as punctures or abrasions.

U.S. Pat. No. 4,361,613 notes, at column 2, lines 10 to 46, that composite or laminated, sandwich-type panels that use a combination of a polystyrene foam, a rigid urethane or a rigid isocyanurate-based foam core with two oppositely disposed, generally parallel exterior facing sheets made of fiberglass reinforced resin materials provide excellent abrasion resistance and an excellent combination of strength and light weight for easy handling. The patentee suggests that these panels fail to meet certain standardized fire tests administered by Underwriter's Laboratories and other test agencies.

US 2002/0119717 provides a composite thermal protective system that is capable of protecting a substrate from a jet fire. The system comprises a lower layer of an active fire protective material and an upper layer of an ablative fire protective material. The system may include a reinforcing material such as graphite (for example, a graphite fabric), a sized woven carbon fiber fabric, fiberglass, a metal mesh, a polyimide, a polybenzoimidazole, a polyamide a ceramic, a silicone or a combination of such materials. Metal silicates such as aluminum silicate may be used as refractory filler.

U.S. Pat. No. 5,401,793 discloses a number of intumescent fire-resistant coating compositions and a fire-resistant material that comprises a base or substrate having laminated thereon a combination of an intumescent fire-resistant coating and inorganic fiber chopped strands. The patentee also teaches that the intumescent fire-resistant coating and at least one layer of incombustible woven fabric made of glass fiber, carbon fiber, etc. may be laminated on a substrate to improve fire resistance of the substrate. The patentee further teaches that when woven glass fabric or woven roving fabric is used, it tends to exert an anchor effect on the intumescence to physically reinforce the intumescence. Suitable substrates include metallic materials, wood-based materials, and inorganic salt molded articles such as plasterboards and calcium silicate boards.

U.S. Pat. No. 5,433,991 teaches use of mastic fire protective coatings, especially those termed “intumescent”, and the use of an embedded mesh to reinforce foam-like char that results when the intumescent coating is exposed to the heat of a fire. The patentee refers to U.S. Pat. No. 5,580,648 which teaches use of a free-floating carbon mesh to anchor mastic intumescent fire protection coatings where the coatings are applied to external surfaces of structural elements of a hydrocarbon processing facility.

U.S. Pat. No. 5,622,774 focuses upon use of a graphite fiber or cardo-polymer cloth to reinforce intumescent coating compositions that are used to protect underlying substrates (for example, static structures such as petroleum storage tanks, chemical production equipment, electrical cable trays and structural steel, or transportation equipment such as tank cars and aircraft cabins) from the spread of flames. In the background section, the patentee refers to U.S. Pat. No. 2,680,077 and U.S. Pat. No. 3,284,216 for thermal protective materials such as silicate solutions or ammonium phosphate paints or compositions.

U.S. Pat. No. 4,292,358 concerns a heat protective barrier that is flexible enough to be wrapped around existing structures such as a liquid petroleum gas container. The barrier consists of one or more layers of an intumescent coating, preferably water-based rather than solvent-based, on an unattached, expanded metal mesh.

U.S. Pat. No. 3,284,216 also teaches intumescent fire-retardant coating or paint compositions suitable for application by conventional means such as brushing, roller applying and spraying onto substrates such as steel I-beam surfaces.

U.S. Pat. No. 5,001,005 teaches thermosetting plastic foam structural laminates that comprise at least one planar facing sheet and rigid foam integrally attached upon formation of the foam to a surface of a facing sheet. The planar facing sheets comprise from 60 percent by weight (wt %) to 90 wt % glass fibers, 10 wt % to 40 wt % non-glass filler material and 1 wt % to 30 wt % of a non-asphaltic binder material (for example, a styrene-butadiene rubber or a polyvinylidene chloride) that bonds the fibers together and bonds the filler materials to the fibers.

U.S. Pat. No. 5,147,710 discloses a low density structural article that comprises a thermoplastic (for example, polyphenylene ether, a polyamide or a polyolefin) resin foam substrate and a flame-resistance-conferring material adhered to a substrate surface. The latter material may be a foil, preferably a metal foil, or a fiberglass mat. A preferred metal foil is an aluminum foil backed by kraft paper. The fiberglass mat may be woven or non-woven and preferably contains filler such as exfoliated vermiculite.

A first aspect of this invention is a laminar composite structure comprising:

a. an insulating foam layer, the foam layer having a first major planar surface and, spaced apart from and generally parallel to the first major planar surface, a second major planar surface; and b. a coating, layer or lamina of an intumescent composition that both covers and adhesively bonds to at least a surface portion, preferably substantially all of at least one major planar surface of the insulating foam layer. The terms “coating”, “layer” and “lamina” may be used interchangeably. The intumescent coating composition preferably forms an adhesive bond with the major planar surface by way of constituents of the composition itself rather than by way of a separate adhesive layer or lamina.

In a related aspect, a porous carbon veil or mat is either disposed within the coating, layer or lamina of the intumescent composition or disposed between two coatings, layers or laminae of the intumescent composition. The carbon veil or mat has sufficient porosity that one need only use a single layer or intumescent composition as the composition, while in a liquid or semi-liquid state, permeates through the veil or mat, effectively encapsulating the veil or mat. In another related aspect, a fiberglass mat is substituted for the carbon veil or mat and disposed between two coatings, layers or laminae of the intumescent composition. In yet another related aspect, a layer or lamina of a moisture vapor barrier material may be applied to the intumescent composition coating, layer or lamina, with or without a carbon veil or a fiberglass mat.

Where ranges are stated in this Application, the ranges include both endpoints of the range unless otherwise stated.

Laminar composite structures of the present invention comprise an insulating foam layer and a coating, layer or lamina of an intumescent composition that both covers and adhesively bonds to the insulating foam layer. The composite structures optionally include a reinforcing medium, preferably a carbon veil mat or a glass fiber mat. If the reinforcing medium is a glass fiber mat, the composite structures include an adhesive layer, preferably a second intumescent layer that, when taken together with the intumescent layer that covers the insulating foam layer, effectively sandwiches the glass fiber mat between two intumescent coating layers or an intumescent coating layer and an adhesive layer. As a variation of the foregoing structure that includes an adhesive layer and an intumescent coating layer, one may reverse the order of the layers such that the adhesive layer covers the foam layer and the intumescent coating covers the glass fiber mat without departing from the spirit or scope of the invention. Carbon veil mats are sufficiently porous that the intumescent coating permeates through the mat, eliminating a need for a second intumescent coating layer or an adhesive layer. The composite structures further optionally include a moisture vapor barrier layer as more fully detailed below.

The insulating foam comprises either polyisocyanurate (PIR) foam or urethane-modified polyisocyanurate foam (PU-PIR). Such foams and their preparation are well known in the art. In general, foam preparation involves reaction of an isocyanate, such as methylene diisocyanate, with an isocyanate-reactive material, such as a polyester polyol, in the presence of a trimerization catalyst and a blowing agent. In preparing PU-PIR foam, water is used as a co-blowing agent. Illustrative patents that teach each of the reactants, the catalyst and blowing agents as well as preparation of PIR foam, PU-PIR foam or both include U.S. Pat. No. 3,909,465, U.S. Pat. No. 3,931,065, U.S. Pat. No. 4,411,949, U.S. Pat. No. 4,247,656, U.S. Pat. No. 4,623,673, U.S. Pat. No. 4,795,763, U.S. Pat. No. 4,898,893, U.S. Pat. No. 5,096,933, and U.S. Pat. No. 5,286,789. The relevant teachings of these references are incorporated herein by reference.

Intumescent compositions and their use in coating a variety of substrates such as steel I-beams are well known. As noted in U.S. Pat. No. 3,915,777 at column 1, lines 16-20, intumescent compositions typically comprise a film-forming material, a carbonaceous material, a spumific agent and a volatile liquid or carrier. The volatile liquid may be water or an organic liquid such as a hydrocarbon, alcohol, ketone, ether or a chlorinated hydrocarbon. Use of water as the volatile liquid eliminates odors inherent in an organic liquid. Spumific agents include, but are not limited to, those listed in U.S. Pat. No. 3,915,777 at column 2, lines 42-52. Illustrative spumific agents include dicyandiamide, melamine pyrophosphate, mono- or diammonium phosphate, polyphosphorylamide, ammonium bromide, sodium tungstate, boric acid, sodium borate and water-insoluble methaphosphates such as those of sodium, potassium, calcium or zinc. Expandable graphite, such as GRAFGuard™ expandable graphite flake grades 160 and 22 commercially available from UCAR Carbon Company Inc., functions as a suitable carbonaceous material. The film-forming material, desirably an organic polymer, may be any material that yields a substantially continuous coating after the volatile liquid evaporates. Illustrative film-forming material includes styrene-acrylic copolymers, chlorinated rubbers, polymers and copolymers of vinyl chloride or vinylidene chloride such as polyvinyl chloride, polyvinylidene chloride, vinylidene chloride/vinyl chloride copolymers.

The intumescent coating composition must include a char forming amount of carbonaceous material to improve the fire performance and at least 40 percent by weight (wt %), based on total coating composition weight, of an inorganic silicate. If a commercially available intumescent coating material does not contain either or both of these amounts, one can simply add, with stirring, a sufficient amount of the material for which there is a shortfall to reach or exceed these amounts. Similarly, one may modify a silicate adhesive composition, preferably a water-based silicate adhesive composition, by adding an amount of char forming carbonaceous material to equal or exceed the above char forming amount. If the carbonaceous material has an average particle size or diameter of 50 micrometers, the char forming amount is at least 10 wt %, preferably at least 15 wt %, more preferably at least 25 wt % and no more than 75 wt %, preferably no more than 60 wt %, in each case based upon total coating composition weight. If the amount of char forming carbonaceous material is less than 10 wt %, then laminar composite structures that incorporate the intumescent coating composition as a layer tend to have an undesirably low fire retardancy, as evidenced by an increase in FSI above 25, together with an undesirably high amount of smoke, as evidenced by a SDI in excess of 50. While amounts in excess of 60 wt %, even as much as 75 wt %, may be used, they increase cost of the laminar composite structure but do not yield an appreciable reduction in FSI. In addition, when the amount of carbonaceous material exceeds 75%, the intumescent coating tends to become too viscous for ease of application and the coating lacks sufficient tackiness to be useful in making satisfactory laminar composite structures. Skilled artisans recognize that carbonaceous materials may also be available in average diameters or particle sizes other than 50 micrometers. They also recognize that if the average particle size is larger (for example, 80 micrometers (μm), then the ranges specified above are adjusted upward. Similarly if the average particle size is smaller (for example, 35 μm) the ranges specified above are adjusted downward. The amount of inorganic silicate ranges from 25 wt % to 75 wt %, based upon total composition weight, preferably from 25 wt % to 50 wt %. If the amount of inorganic silicate is less than 25 wt %, then laminar composite structures that include a layer of the intumescent coating composition do not attain the FSI and SDI values needed to pass ASTM E-84 testing. As with the carbonaceous material, the inorganic silicate may be used in an amount in excess of 75 wt %, but doing so only increases the cost while not appreciably improving ASTM E-84 SDI and FSI values.

Commercially available intumescent coatings that function well in laminar composite structures of the present invention and have amounts of carbonaceous material and inorganic silicate that fall within the ranges specified above include HY-TECH™ HD-1, a water-based, low volatile organic content, insulating intumescent coating composition commercially available from Hy-Tech Thermal Solutions, LLC. HT1-GP and HT1-ED intumescent coating compositions, also available from Hy-Tech Thermal Solutions, LLC should also provide satisfactory results.

Apply coatings to a major planar surface of PIR foam or PU-PIR using conventional procedures such as roller coating or spraying to yield a coating of desired thickness. The coatings have a thickness that desirably ranges from 1 mil (0.001 inch (in.) or 0.0254 millimeter (mm)) to 100 mils (0.10 in. or 2.54 mm), preferably from 5 mils (0.005 in. or 0.13 mm) to 70 mils (0.070 in. or 1.78 mm), more preferably from 8 mils (0.008 in. or 0.20 mm) to 50 mils (0.050 in. or 1.27 mm) and most preferably from 10 mils (0.010 in. or 0.25 mm) to 30 mils (0.030 in. or 0.76 mm). The above coating thicknesses are wet coating thicknesses determined within five (5) minutes after coating application using a wet mil thickness gauge available from Sherwin Williams. A coating thickness of less than 1 mil (0.001 in. or 0.0254 mm) provides very little, if any, enhancement of FSI or SDI over that of uncoated foam. A coating thickness of more than 100 mils (0.100 in. or 2.54 mm) increases both weight and cost of a laminar composite and may be counterproductive in that it might tend to slough off during burning.

The moisture vapor layer (also known as a “water vapor retarder layer”) may comprise any material that minimizes exposure of the underlying insulating foam layer to water, thereby lessening adverse effects of such exposure. PIR foam and PU-PIR foam have a tendency to absorb small amounts of water vapor over extended time periods (for example, 0.5 wt %, based upon weight of foam over a period of two (2) days when tested in accordance with ASTM C272) and permeate low amounts of water vapor through the foam over an extended period of time (for example, 4 perm-inch) (6.25 nanograms per Pascal.second.meter (ng/Pa.S.m)(over a 4 to 5 day period at high humidity (for example, 97 to 99 percent humidity) when one side of a PIR or PU-PIR foam sheet is exposed to an appreciably higher temperature than the other side. Such conditions exist in an air conditioned home that is insulated with PIR or PU-PIR foam sheet when the relative humidity is in excess of 95%, the outside temperature is more than 90 degrees Fahrenheit (32° centigrade (° C.)) and the inside temperature is 70° F. (21° C.) or less. The absorbed water vapor reduces thermal barrier performance of the foam as compared to the foam before it absorbs the water vapor. In addition, components of the PIR foam and PU-PIR foam tend to react with water and degrade foam structure.

The carbon veil or mat is suitably a graphite cloth such as that taught in U.S. Pat. No. 5,622,774; U.S. Pat. No. 5,580,648; U.S. Pat. No. 5,433,991; and U.S. Pat. No. 5,401,793. The graphite cloth may be either substantially pure carbon or a precursor material, as is well known in the art. Suitable carbon veils or mats include polyacrylonitrile non-woven carbon mats commercially available from Hollingsworth & Vose Company under the trade designation AFN®, with grades 8000014 and 8000015 being particularly suitable. The carbon veil or mat desirably has a basis weight of from 0.2 ounce per square yard (oz/yd²) (6.8 grams per square meter (g/m²) to 20 oz/yd² (680 g/m²), preferably from 0.2 oz/yd² (6.8 g/m²) to 2 oz/yd² (68 g/m²).

The fiberglass mat is suitably a fiberglass fabric such as that taught in U.S. Pat. No. 5,622,774. Illustrative fiberglass mats include ARMORWELD® fiberglass cloths commercially available from EMTECH. Plain white fiberglass cloths are available in various weights in the ARMORWELD® series WF and heat cleaned fiberglass cloths are available in various weights in the ARMORWELD® series HCF.

Preparation of a laminar composite of the present invention begins with an insulating foam layer, preferably a PIR or PU-PIR foam substrate having a thickness of at least 0.5 inch (1.27 centimeter (cm)), more preferably within a range of from 0.5 in. (1.27 cm) to 1.5 in. (2.81 cm). Thicker PIR or PU-PIR foam substrates of up to two inches (5.1 cm) or even larger provide satisfactory performance from a FSI and SDI perspective, but increasing thickness may pose some challenges where space limitations are a key limitation. The substrate may be in the form of a planar sheet or board with two substantially planar, but spaced apart, major planar surfaces. The substrate may also be in the form of a curvilinear structure suitable for application around a pipe or conduit or around parts of equipment such as around chillers or condensers in a chilled water system. The curvilinear structure is suitably present as two hollow semi-cylindrical shell segments that, when taken together, form a hollow cylinder or conduit. If desired, a greater number of shell segments may be used so long as the segments, when taken together, form a hollow cylinder of conduit. Each shell segment has an outer shell surface and an inner shell surface.

Apply either an intumescent coating or an adhesive coating to the outer shell surface or a major planar surface, whichever is appropriate for the insulating foam layer of choice. The adhesive coating, preferably a water-based silicate adhesive, may, if desired, be modified to include an amount of expandable graphite.

If desired, the intumescent coating or adhesive coating may be covered by a facer material. Suitable facer materials include a polyvinylidene chloride film, a foil-scrim-kraft paper trilaminate structure, an all service jacket (ASJ) or another conventional facer material. Particularly suitable results follow when the facer material is a polyvinylidene chloride film.

When using either an intumescent coating and/or an adhesive coating, whether the adhesive coating is modified or not, adding a reinforcing mat usually improves one or both of the FSI or SDI. If the reinforcing mat is a carbon veil mat, simply place it on the intumescent coating or the adhesive coating, whether modified as above or not, while the coating is still wet. The carbon veil mat is sufficiently porous that the coating permeates through the mat and effectively encapsulates the carbon veil mat as a free-floating mat within the coating layer. If the reinforcing mat is a glass fiber mat, such as a heat-cleaned fiberglass cloth, the coating, whether intumescent or adhesive, penetrates through the mat or cloth to a much lesser degree that through the carbon veil mat. When using a glass fiber mat, it is often necessary to a second adhesive coating or a second intumescent coating to that side of the glass fiber mat not previously in contact with a coating, either adhesive or intumescent. With a glass fiber mat as the reinforcing mat, suitable structures include, among other possible laminar composite structures, the following: foam substrate/intumescent coating/glass fiber mat/adhesive coating/facer; foam substrate/adhesive coating/glass fiber mat/intumescent coating/facer; foam substrate/modified adhesive coating/glass fiber mat/adhesive coating/facer; foam substrate/adhesive coating/glass fiber mat/modified adhesive coating/facer; foam substrate/modified adhesive coating/glass fiber mat/modified adhesive coating/facer; foam substrate/intumescent coating/glass fiber mat/modified adhesive coating/facer; and foam substrate/modified adhesive coating/glass fiber mat/intumescent coating/facer. Skilled artisans readily understand that further variations of these example structures may be made without departing from the scope of the present invention.

The following examples illustrate, but do not in any way limit, the present invention. Arabic numerals represent examples (Ex) of the invention and letters of the alphabet designate comparative examples (Comp Ex). All parts and percentages are by weight unless otherwise stated. In addition, all amounts shown in the tables are based on weight of polymer contained in the respective compositions unless otherwise stated.

### EX 1

Spread a carbon veil mat (AFN® Grade 80014), Hollingsworth & Vose Company Advanced Fiber Nonwovens) that has a basis weight of 0.20 ounce per square yard (oz/yd2) (6.8 grams per square meter (g/m2)) over one major planar surface of a PIR foam substrate (TRYMER™ 2000i, The Dow Chemical Company) that has a thickness of 1.5 inch (in.) (3.8 centimeter (cm). Apply an intumescent coating composition (HT-1 GP, Hy-Tech Thermal Solutions) to the carbon veil mat using an application base of 1 gallon per 100 square feet (gal/ft²) (0.41 liters per square meter (L/m²) to obtain a wet coating thickness of 0.3 in. (0.76 millimeter (mm)). Determine wet coating thickness using a wet thickness gauge available from a Sherwin Williams paint store. The coating composition permeates through the carbon veil mat and contacts the PIR foam major planar surface, effectively providing a free floating carbon veil mat disposed within the coating composition. Apply a polyvinylidene chloride film (SARAN™ 540, The Dow Chemical Company) having a thickness of 4 mils (0.004 in.) (0.10 mm) to the coating composition. The coating composition, when dried, effectively bonds to both the PIR foam major planar surface and the polyvinylidene chloride polymer film, thereby forming a laminar composite structure.

### COMP EX A

Replicate Ex 1, but omit the carbon veil mat.

### EX 2

Replicate Comp Ex A, but include a seam by partially overlapping two plies of the polyvinylidene chloride film and seal the seam with a two-sided, pressure sensitive adhesive tape that uses a polyamide or nylon film as a base for the pressure sensitive adhesive (3693 FLE\FR, Venture Tapes). “FLE” means “finger lift edge”. The partially overlapping seal simulates an insulating pipe wrap installation.

### EX 3

Replicate Ex 2, but substitute a coating of the intumescent composition for the two-sided pressure sensitive adhesive tape to seal the seam.

### COMP EX B

Replicate Ex 1, but include a coated seam as in Ex 2.

### EX 4

Replicate Ex 1, but include a coated seam as in Ex 3.

### COMP EX C

Replicate Ex 1, but include a coated seam as in Ex 3 and substitute a paper-based all service jacket (ASJ) for the polyvinylidene chloride film. ASJ (FB 400 ASJ from Compac Corporation) is a trilaminate of 0.3 mil (0.00035 in./9 micrometers) aluminum foil adhesively bonded to a kraft paper (45 pounds (lb)/3000 ft²) (75 grams per square meter (g/m²)) with a fiberglass scrim sandwiched in between. The adhesive is a Flame retardant adhesive.

### EX 5

Coat a major planar surface of a PIR foam substrate (TRYMER™ 2000i, The Dow Chemical Company) that has a thickness of 1.5 inch (in.) (3.8 centimeter (cm) with an intumescent coating (STAHRCOAT™, Barrier Dynamics) at a rate of one gallon per 50 ft2 (0.815 L/m²).

Subject Ex 1 through Ex 5 and Comp Ex A through Comp Ex C to ASTM E-84 testing and summarize the results in Table I below.

TABLE I

| Ex/Comp | | |
|---|---|---|
| Ex | | |
| Designation | ASTM E-84 FSI | ASTM E-84 SDI |
| 1 | 20 | 40 |
| A | 30 | 45 |
| 2 | 25 | 45 |
| 3 | 25 | 30 |
| B | 30 | 30 |
| 4 | 20 | 15 |
| C | 35 | 130 |
| 5 | 25 | 250 |

The data in Table I demonstrate that the laminar structures of Ex 1, Ex 2, Ex 3 and Ex 4 have ASTM E-84 FSI and SDI numbers that are suitable for use in air return plenums that carry insulated hot water pipes and insulated cold water pipes in commercial buildings such as schools, office buildings and hospitals. The data suggest that by substituting a polyvinylidene chloride film for the ASJ of Comp Ex C, the laminar structure of Comp Ex C should attain a lower FSI rating of no more than 25. Even if the SDI number did not change with such a substitution, the resulting laminar structure would have ASTM E-84 FSI and SDI numbers that are suitable for building panels. In addition, the FSI measurements for Comp Ex A and Comp Ex B are close enough to the ASTM E-84 FSI and SDI pass/fail numbers for air return plenums that minor variations in structure and/or composition of Comp Ex A and Comp Ex B should yield passing FSI and SDI numbers. Similar results are expected with other laminar structures that represent the present invention, but vary in one or more aspects according to the teachings presented hereinabove. It is believed that replicating Ex 2 with a polyester-based pressure sensitive adhesive tape instead of the nylon-based pressure sensitive adhesive tape of Ex 2 would result in much higher FSI and/or SDI numbers that would result in a failure to pass ASTM E-84 criteria for air return plenums.

### EX 6

Modify a water-based silicate adhesive (CALBOND™ Gold, Industrial Insulation Group, LLC) by adding 25 wt %, based on coating weight, of expandable graphite (GRAFGUARD™ 160-50, average particle size of 50 micrometers, expansion volume at 600° C. of 250 cubic centimeters per gram (cm³/g), UCAR Carbon Co.). Apply a coating of the modified silicate adhesive over a major planar surface of a PIR foam substrate (TRYMER™ 2000i, The Dow Chemical Company) that has a thickness of 1.5 inch (in.) (3.8 centimeter (cm). Apply an unseamed layer of the same polyvinylidene chloride film as in Ex 1 to the modified adhesive before the adhesive dries to form a laminar composite structure. The laminar composite structure's ASTM E-84 FSI and SDI numbers are, respectively, 25 and 60. The numbers indicate that the laminar composite structure is suitable for use as a building panel rather than in air return plenums that carry insulated hot water pipes and insulated cold water pipes in commercial buildings such as schools, office buildings and hospitals. Further modification of the laminar composite structure may make it suitable for use in such air return plenums.

### EX 7

Replicate Ex 6 with two modifications. First, apply a 30 mil (0.76 mm) thick heat cleaned fiberglass cloth (Armil/CFS, 18-HCF-40-50) to the modified silicate adhesive coating. Second, apply a coating of the unmodified silicate adhesive (CALBOND™ Gold, Industrial Insulation Group, LLC) to a side of the fiberglass cloth that is not in contact with the modified silicate adhesive. The laminar composite structure's ASTM E-84 FSI and SDI numbers are, respectively, 15 and 5, making it suitable for use in either air return plenums or building panels.

### EX 8

Replicate Ex 7 with one modification. First, substitute a coating of the same intumescent coating composition as in Ex 1 for the modified silicate adhesive of Ex 6. The laminar composite structure's ASTM E-84 FSI and SDI numbers are, respectively, 25 and 65, making it suitable for use in building panels. With further modification of the laminar composite structure, reduction of the SDI number to 50 or below should be possible, thereby making the further modified version suitable for use in air return plenums.

### EX 9

Replicate Ex 8, but reverse the order of the intumescent coating and the silicate adhesive such that the silicate adhesive lies between the major planar surface of the foam and the heat cleaned fiberglass cloth. The laminar composite structure's ASTM E-84 FSI and SDI numbers are, respectively, 15 and 70, results that make it suitable for the same purposes as Ex 8 and amenable to further modifications like those suggested for Ex 8.

### EX 10

Replicate Ex 7, but reverse the order of the unmodified silicate adhesive and the modified silicate adhesive. The laminar composite structure's ASTM E-84 FSI and SDI numbers are, respectively, 20 and 10, making it suitable for use in either air return plenums or building panels.

### COMP EX D

Replicate Ex 7 with three modifications. First, substitute a carbon veil mat identical to that used in Ex 1 for the heat cleaned fiberglass cloth. Second, substitute the unmodified silicate adhesive of Ex 7 for the modified silicate adhesive of Ex 6. Third, eliminate the coating of silicate adhesive that is applied over the fiberglass cloth in Ex 7 as the carbon veil mat is sufficiently porous that the coating of silicate adhesive applied to the foam major planar surface penetrates through the carbon veil mat and effectively encapsulates the carbon veil mat in the silicate adhesive coating. The laminar composite structure's ASTM E-84 FSI and SDI numbers are, respectively, 45 and 75. These numbers suggest that further modification of the laminar composite is needed to make it suitable for use in building panels or air return plenums.

### COMP EX E

Replicate Comp Ex D, but modify it to eliminate the carbon veil mat. The laminar composite structure's ASTM E-84 FSI and SDI numbers are, respectively, 50 and 70. As with Comp Ex D, these numbers suggest that further modification of the laminar composite is needed to make it suitable for use in building panels or air return plenums.

### Ex 11-15

Cut PIR Foam (TRYMER™ 2000i, The Dow Chemical Company) into boards having a length of two feet (ft) (0.61 meter (m)), a width of 3.5 in. (8.9 cm) and a thickness of 1.0 in. (2.5 cm). The boards are of a size suitable for testing in accordance with ASTM D 3086-79 (Standard Test Method of Small-Scale Evaluation of Fire-Retardant Paints (2-ft Tunnel Method).

### EX 11

Replicate Ex 1 with two changes. First, use a 2 ft (0.61 m), 1.0 in. (2.5 cm) thick PIR foam board rather than the 1.5 in. (3.8 cm) thick foam substrate. Second, omit the carbon veil mat.

### EX 12

Replicate Ex 11 but substitute ECOFLEX™ (Avtec) intumescent coating for the intumescent coating of Ex 11.

### EX 13

Replicate Ex 12 with one change. That change involves applying the same type of carbon veil mat as in Ex 1 using the procedure outlined in Ex 1.

### EX 14

Replicate Ex 6 but use a 2 ft (0.61 m), 1.0 in. (2.5 cm) thick PIR foam board rather than the 1.5 in. (3.8 cm) thick foam substrate.

### EX 15

Replicate Ex 14 but increase the loading of expandable graphite instead to 50 wt %, based on coating weight.

Subject Ex 11-15 and, for purposes of comparison, a 2 ft (0.61 m), 1.0 in. (2.5 cm) thick PIR foam board that has no intumescent coating or facer, designated as Comp Ex F, to testing in accordance with ASTM D 3086-79 (Standard Test Method of Small-Scale Evaluation of Fire-Retardant Paints (2-ft Tunnel Method) to gather data relative to FSI and SDI for the samples. As noted on page 2 of ASTM D 3086-79, “[b]y calibrating the 2-ft tunnel with Method E-84-rated fire retardant paint, results obtained by this method should be indicative of those obtained with a large specimen in E-84 tunnel” testing such as that done in Ex 1-10 above. Table II below summarizes test results for flame spread (FS), calibrated in one in. (2.54 cm) sections at 15 second intervals. In other words, it shows how far down the tunnel the flame spreads. Table II also includes two subjective ratings. One subjective rating rates smoke developed (SD) on a scale of 1 to 5 where 1 is the best rating and indicates relatively low smoke development and 5 is the worst rating and indicates a relatively high level of smoke development. The other subjective rating is on quality of burn based upon intensity or brightness of the flame. Poor means the flame is quite bright and best means that the flame is much less intense than that which rates as “poor”. Good and better represent intermediate ratings.

TABLE II

| | Comp | | | | | | | | | | | |
|---|---|---|---|---|---|---|---|---|---|---|---|---|
| | Ex F | | Ex 11 | | Ex 12 | | Ex 13 | | Ex 14 | | Ex 15 | |
| Time | FS | SD | FS | SD | FS | SD | FS | SD | FS | SD | FS | SD |
| 0:15 | 24 | ND* | 12 | 1 | 18 | 3 | 10 | 5 | 12 | 2 | 11 | 3 |
| 0:30 | 15 | | 12 | | 18 | | 15 | | 12 | | 11 | |
| 0:45 | 13 | | 11 | | 18 | | 16 | | 12 | | 11 | |
| 1:00 | 12 | | 9 | | 17 | | 17 | | 10 | | 11 | |
| 1:15 | 11 | | 9 | | 15 | | 15 | | 10 | | 10 | |
| 1:30 | 10 | | 9 | | 12 | | 13 | | 10 | | 10 | |
| 1:45 | 10 | | | | 12 | | 13 | | 9 | | 10 | |
| 2:00 | 10 | | | | 12 | | 12 | | 8 | | 10 | |
| 2:15 | 10 | | | | 12 | | 12 | | 8 | | 10 | |
| Quality | Poor | | Good | | Good | | Better | | Best | | Best | |
| of Burn | | | | | | | | | | | | |

*ND means Not Determined

The data presented in Table II demonstrate that PIR foam that lacks an intumescent coating or a facer, as in Comp Ex F, fares very poorly in flammability testing in accordance with ASTM D 3086-79. Under the same test protocol, Ex 11 and Ex 12, when compared to Ex 13, show that good test results are improved, at least from a burn quality point of view, when a carbon veil mat is included in a laminar structure. Ex 14, in conjunction with Ex 6, validates the premise that ASTM D 3086-79 testing can be correlated with ASTM E-84 testing. Ex 15 illustrates that the amount of carbonaceous material (expandable graphite in the examples) can be substantially increased without adversely affecting performance of the laminar structures in response to flammability testing. Similar results are expected with other laminar structures that represent the present invention, but vary in one or more aspects according to the teachings presented hereinabove.

### EX 16-18

Replicate Ex 2 three times but reduce the intumescent wet coating thickness to 10 mils (0.010 in. or 0.25 mm) in each instance. ASTM E-84 testing as in Ex 5 yields the following ASTM E-84 FSI/ASTM E-84 SDI values: Ex 16=25/35; Ex 17=25/30; and Ex 18=25/35.

### EX 19

Replicate Ex 2, but reduce the intumescent wet coating thickness to 10 mils (0.010 in. or 0.25 mm) as in Ex 16-18 and change the intumescent coating to HT1-ED (Hy-Tech Thermal Solutions). ASTM E-84 testing as in Ex 5 yields the following ASTM E-84 FSI/ASTM E-84 SDI values: 25/35.

### EX 20

Replicate Ex 16, but dilute the coating composition by adding water in an amount of five percent by weight (wt %), based upon coating weight. ASTM E-84 testing as in Ex 5 yields the following ASTM E-84 FSI/ASTM E-84 SDI values: 25/20.

### EX 21

Replicate Ex 20, but increase the amount of added water to 10 wt %, based upon coating weight. ASTM E-84 testing as in Ex 5 yields the following ASTM E-84 FSI/ASTM E-84 SDI values: 25/35.

The data presented in Ex 16-21 show that relatively thin (10 mils or 0.010 in. or 0.25 mm) intumescent coatings yield ASTM E-84 FSI and SDI values that make the laminar composites suitable for a variety of end use applications. The results are favorable with some dilution of the coating compositions as well as with neat coating compositions. Similar results are expected with other coatings within the scope of the present invention.

### COMP EX F-H

For each of Comp Ex F-H, bond one major planar surface of the same type of PIR foam substrate as in Ex 1 to a cementatious board using CALBOND™ (a calcium silicate based adhesive made by IIG) as an adhesive. ASTM E-84 testing as in Ex 5 yields the following ASTM E-84 FSI/ASTM E-84 SDI values: Comp Ex F=25/40; Comp Ex G 25/105; and Comp Ex H=25/55.

### COMP EX I

Replicate Ex 16, but substitute a coating of a vinyl acrylic latex-based fire retardant coating composition that contains titanium dioxide as a pigment (220 Latex Fire Retardant Coating, Benjamin Moore & Co.) for the intumescent coating of Ex 16. ASTM E-84 testing as in Ex 5 yields the following ASTM E-84 FSI/ASTM E-84 SDI values: 25/300.

### EX 22

Replicate Ex 4, but reduce the intumescent wet coating thickness to 10 mils (0.010 in. or 0.25 mm) as in Ex 16-18. ASTM E-84 testing as in Ex 5 yields the following ASTM E-84 FSI/ASTM E-84 SDI values: 25/35.

### EX 23 and EX 24

Replicate Ex 22 two times, but change the PIR foam substrate to TRYMER™ 2000 blue (The Dow Chemical Company). ASTM E-84 testing as in Ex 5 yields the following ASTM E-84 FSI/ASTM E-84 SDI values: Ex 23=25/45; and Ex 24=25/20.

### COMP EX J AND COMP EX K

Replicate Comp Ex F two times, but substitute a developmental PIR foam that contains 6 parts, per hundred parts by weight of PIR foam, of FYROL™ PCF (a Tris Chloro Phenyl Phosphate (TCPP) fire retardant) as a flame retardant additive for the PIR foam substrate used in Comp Ex F. ASTM E-84 testing as in Ex 5 yields the following ASTM E-84 FSI/ASTM E-84 SDI values: Comp Ex J=25/130, and Comp Ex K=25/85.

### COMP EX L-N

Replicate Comp Ex F three times, but reduce the thickness of the foam substrate to 1 in. (2.5 cm). ASTM E-84 testing as in Ex 5 yields the following ASTM E-84 FSI/ASTM E-84 SDI values: Comp Ex L=25/65; Comp Ex M=25/50; and Comp Ex N=25/40.

The spread in SDI values for each instance of multiple runs (for example, Comp Ex F-H and Ex 23-24) is believed to be due, at least in part, to variability in the E-84 test tunnel as well as some variation between PIR foam sheets cut from a PIR foam bun. Skilled artisans understand that, in ASTM E-84 testing, exposure of foam to flame causes the foam to heat up until it reaches autoignition temperature. Once the foam starts burning, it begins to crack with crack propagation occurring both along the foam's length and transverse to the foam's length. Concurrent with crack propagation, the foam begins to char and generate smoke. As cracks develop, fresh foam surface is exposed to the flame, which leads to further charring and smoke generation. Laminar composite structures of the present invention, as represented by Ex 1-24, provide more consistent FSI/SDI values at or below 25/50 than the structures of Comp Ex A-N.

1. A laminar composite structure comprising:
a. an insulating foam layer, the foam layer having a first major planar surface and, spaced apart from and generally parallel to the first major planar surface, a second major planar surface; and
b. at least one coating, layer or lamina of an intumescent composition that both covers and adhesively bonds to at least one major planar surface of the insulating foam layer.

2. The laminar composite structure of claim 1, wherein the composite structure further comprises a carbon veil mat, the carbon veil mat being embedded in a single coating of the intumescent coating composition.

3. The laminar composite structure of claim 1, wherein the composite structure further comprises a reinforcing medium selected from a carbon veil mat or a fiberglass mat, the reinforcing medium being disposed between, and adhesively bonded to, two coatings, layers or laminae of the intumescent coating composition.

4. The laminar composite structure of any of claim 1, wherein the composite structure further comprises a moisture vapor barrier lamina, the moisture vapor lamina comprising a facer material selected from a vinylidene chloride polymer film, a metal foil, a metal foil-scrim-kraft paper laminate, or a polyethylene terephthalate film-metal foil-polyethylene terephthalate film laminate.

5. The laminar composite structure of claim 4, wherein the moisture vapor barrier lamina is a vinylidene chloride polymer film.

6. The laminar composite structure of any of claim 1, wherein the intumescent coating comprises water based admixture of expandable graphite, clay, imides, carbon black, and a silicate.

7. The laminar composite structure of claim 4, wherein the intumescent coating comprises water based admixture of expandable graphite, clay, imides, carbon black, and a silicate.

8. The laminar composite structure of claim 1, wherein the insulating foam layer comprises polyisocyanurate foam or urethane-modified polyisocyanurate foam.

9. The laminar composite structure of claim 4, wherein the insulating foam layer comprises polyisocyanurate foam or urethane-modified polyisocyanurate foam.

10. The laminar composite structure of claim 6, wherein the inorganic silicate is selected from the group consisting of sodium silicate, calcium silicate, aluminum silicate.

11. The laminar composite structure of claim 7, wherein the inorganic silicate is selected from the group consisting of sodium silicate, calcium silicate, aluminum silicate.

12. The laminar composite structure of claim 1, wherein the composite has an ASTM E-84 flame spread index of 25 or less and a smoke developed index of 50 or less.

13. The laminar composite structure of claim 1, wherein the composite has an ASTM E-84 flame spread index of 25 or less and a smoke developed index of 450 or less.

14. The laminar composite structure of claim 1, wherein the coating has an as applied thickness of from 1 mil (0.0254 millimeter (mm)) to 100 mils (2.54 mm).

15. The laminar composite structure of claim 14, wherein the thickness is from 5 mils (0.13 mm) to 70 mils (1.78 mm).

16. The laminar composite structure of claim 14, wherein the thickness is from 8 mils (0.20 mm) to 50 mils (1.27 mm).

17. The laminar composite structure of claim 14, wherein the thickness is from 10 mils (0.25 mm) to 30 mils (0.76 mm).
